(19) United States
(12) Patent Application Publication
(10) Pub. No.: US 2018/0118551 A1
(43) Pub. Date: May 3, 2018

(54) DEVICE FOR FILLING A CONTAINER WITH BEVERAGES THROUGH THE BOTTOM OF SAID CONTAINER

(71) Applicant: Drink Up, Tethieu (FR)

(72) Inventor: Olivier JAMMES, Tethieu (FR)

(73) Assignee: DRINK UP, Tethieu (FR)

(21) Appl. No.: 15/565,799

(22) PCT Filed: Apr. 14, 2016
(86) PCT No.: PCT/FR2016/050854

§ 371 Date: Oct. 11, 2017

(30) Foreign Application Priority Data
Apr. 14, 2015 (FR) 1500810

(51) Int. Cl. B67D 1/14; B67D 1/12; B67D 1/00

(52) U.S. Cl. CPC B67D 1/1422; B67D 1/1272; B67D 2210/00065; B67D 1/0003; B67D 2001/1483; B67D 1/0085

(57) ABSTRACT

Device for filling a beverage container (4) through the bottom (11) thereof, comprising a solenoid valve (2), a filling nozzle (1) intended to be introduced through a self-sealing member (5) arranged in one of the walls of the container (4), the nozzle (I) comprising an internal duct and an injection outlet (9) and exhibiting an axis that is off-centered from the center of the bottom (I 1) of the container (4) and the orientation of the outlet of the injection outlet (9) of which follows an angle 0, with respect to the axis X along a plane containing the vertical axis of the container (4), and the axis of the center of the filling nozzle (I), said angle 0 being greater than 60° , and the injection outlet of the nozzle being, on the one hand, inclined and, on the other hand, positioned some distance away from the bottom (11) of the container (4) when the latter is in the filling position.

### CROSS REFERENCE TO RELATED APPLICATION

This application is a national stage entry of PCT/FR2016/050854 filed Apr. 14, 2016, under the International Convention claiming priority over French Patent Application No. 1500810 filed Apr. 14, 2015.

### TECHNICAL FIELD OF THE INVENTION

The present invention relates to a method for filling a container with beverage, notably via its bottom.

### BACKGROUND ART

The method is based on the combination of a feed device, the injection nozzle of which has a special configuration and a special geometric shape, and of a special design of the container, the assembly affording significant improvements by comparison with the systems for filling vessels from the bottom.

The device thus designed, through a geometric and hydrodynamic approach, makes it possible simultaneously to limit the formation of a prohibitive head of foam at the surface of the gaseous liquid inside the container, to avoid an increase in the temperature of the beverage during filling, to guarantee better preservation of the beverage, to obtain a filling process that is repeatable, and to optimize the handling of the container while at the same time ensuring the safety of the operator.

Devices based on the principle of filling a container, such as a glass or cup, by injecting the beverage through the actual bottom thereof do actually exist, but ultimately do not simultaneously and wholly address all of the difficulties encountered when desiring to fill a beverage container from its bottom, repeatably, without spilling droplets, without producing a prohibitive head of foam at the surface of gaseous beverages and at the same time ensuring the best safety for the operator.

### SUMMARY OF THE INVENTION

The present invention does address these disadvantages. It affords a solution for significantly minimizing the formation of the head of foam at the surface of gaseous beverages during filling of the vessel, or cup or any other type of container from the bottom. It relates to the association of a filling device liquid injection nozzle, which is introduced through a self-sealing member, or nonreturn valve, incorporated into the bottom wall of the cup, characterized on the one hand by its special geometry and on the other hand by that of the container itself, the nonreturn valve of which is ideally positioned to conform to the fundamental principles of hydrodynamics that encourage laminar flow.

Specifically, it is well known that the production of turbulent flow automatically generates a significant emulsion of gas bubbles and therefore generates a great deal of foam, for example in the case of beer.

Conversely, the production of a laminar jet, the stream lines of which follow the wall of the vessel as tangentially as possible, leads to a very appreciable improvement in the result. A laminar flow also has the advantage of being repeatable and predictable, the consequence of this being that container fillings will be able to be obtained under conditions that are invariable and repeatable.

To sum up, the invention described relates to:

an assembly for filling a beverage container, through the bottom thereof, comprising, a filing device and a beverage container exhibiting a circular bottom and a vertical central axis, the filling device comprising a solenoid valve and a presence sensor, the filling nozzle of which is intended to be introduced through a self-sealing member , the filling nozzle comprising an internal duct and an injection outlet which is inclined so that it curves progressively downward by a negative angle alpha comprised between −5° to −30° degrees so as to direct the jet of beverage downward at a tangent to the inside of the bottom of the container.

The filling device, of which the filling nozzle, of an exterior shape that is preferably cylindrical with a hemispherical or ogee-shaped head, comprises an internal duct of variable cross section.

The filling device in which a filling nozzle, the vertical axis of which is preferably off-centered from the center of the bottom of the container and the orientation of the outlet of the injection outlet of which follows an angle theta, preferably greater than 60° with the axis respect to the axis X along a plane containing vertical of the container and the axis vertical of the center of the filling nozzle, directs the jet of beverage leaving the filling nozzle along a path tangential to the inside of the lateral wall.

The filling device of which the filling nozzle, or part of the supporting structure of the filling device has a shoulder halting the introduction travel of the container and thus creating a bearing surface positioning the injection outlet at a fixed distance away from the bottom of the container during filling.

The filling device of which the sensor, through its exterior shape, precision-guides the exterior wall of the container during introduction of the nozzle and is able to detect the presence of the container.

The filling device of which a collecting tray is intended to catch the beverage when the solenoid valve releases the beverage in the absence of the container.

The container able to collaborate with the device of which the self-sealing member is fixed to the bottom of the container by a sealing ring, which may be positioned either on the inside or on the outside of the container, using a mechanical assembly, chemical assembly, or an assembly by welding to the container.

The container able to collaborate with the device of which the self-sealing member is fixed or embedded actually within the very thickness of the material of the wall of the container, with or without the sealing ring being present.

A fixed or mobile apparatus which comprises at least two devices and which is intended to accept containers.

### BRIEF DESCRIPTION OF THE DRAWINGS

FIG. 1 shows a view of the combination of the beverage filling device, equipped with a nozzle, and of any vessel or cup, referred to here as a container, positioned during the course of filling;

FIG. 2 shows a view of the combination of the beverage filling device, equipped with a nozzle, and of this container, before or after filling;

FIG. 3 shows a view from above in section on A.A according to FIG. 1, depicting the relative geometric positioning of the nozzle in its container;

FIG. 4 is detail B of FIG. 2;

FIGS. 5 and 6 illustrate the flow in the bottom of the beverage container during the filling phase; and

FIG. 7 illustrates an example of how two filling methods are integrated into one and the same apparatus.

### DETAILED DESCRIPTION OF THE INVENTION

The device of the invention, which allows a container to be filled with the beverage via its bottom, comprises:

a solenoid valve (2) supplying the beverage to the injection filling nozzle (11) of the container (4) a filling nozzle (1) equipped with a head (8) and with an outlet (9);

a sensor (3) detecting the presence of the container;

a beverage container (4) consisting of a wall (12) and of a bottom (11);

a sealing ring (6) arranged in the orifice (7) and fixed to the bottom;

a self-sealing member (5) which may be a membrane or a flexible nonreturn valve or a rigid nonreturn shutter, fixed between the sealing ring (6) and the bottom (11) of the container (4);

a shoulder (10) or base;

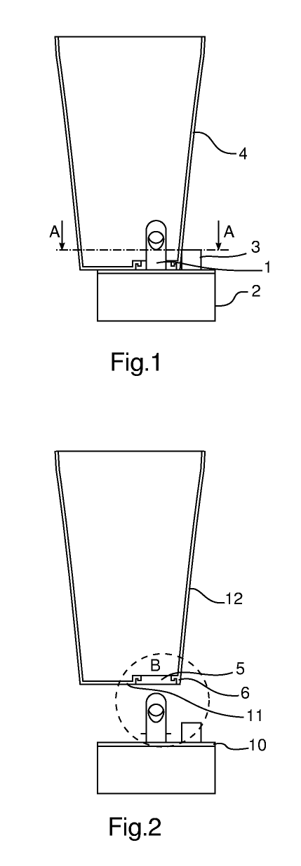

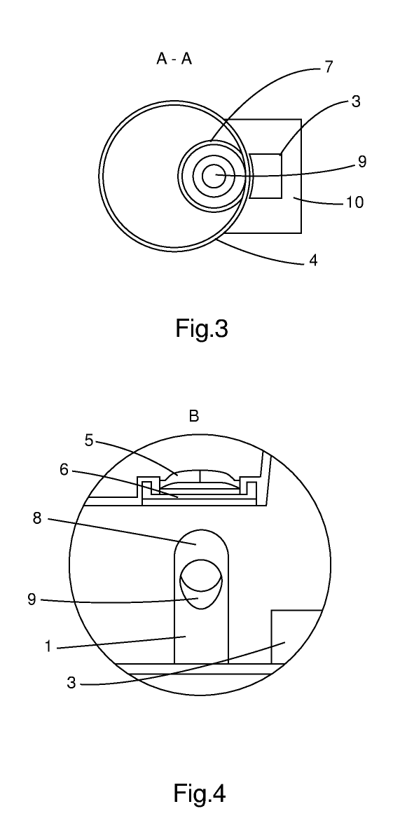

More specifically, the arrangement and makeup of the various elements can be seen in greater detail in FIGS. 1, 2, 3:

The filling device proper comprises a solenoid valve (2) connected in the conventional way directly by piping to the beverage supply circuit (not depicted). In its upper part, in the region of its outlet orifice, are the filling nozzle (1) and a presence sensor (3).

The container (4) comprises, in its bottom (11), a sealing ring (6) crimped or fixed in its lower part into the orifice (7) of the container, and which can just as well be installed on the inside as on the outside of the wall. The sealing ring (6) is deliberately positioned as close as possible to the wall of the container (2).

Between this sealing ring (6) and the bottom (11) of the container (4) is fixed the self-sealing member (5).

The filling nozzle (1) is preferably of cylindrical shape with a hemispherical or ogee-shaped head (8) to make it easier for it to penetrate the self-sealing member (5) progressively without damaging the latter. The self-sealing member (5) makes permanent contact with the exterior shape of the nozzle (1) during the three phases of introduction, filling and withdrawal, creating permanent sealing of the container (4).

FIG. 4 indeed shows the shape of the outlet of the injection outlet (9) the internal part of which curves progressively with a downward inclination by a negative angle of between 5 and 15° . The filling nozzle (1) also comprises, in its lower part, a shoulder (10) or base, creating a bearing surface for the ideal heightwise positioning of the cup when it is in the filling phase.

The relative heightwise position of the injection outlet (9) is optimized so that the direction of the jet of beverage follows a path at a gentle slope, tangential to the wall (12) and to the bottom (11) of the container (4).

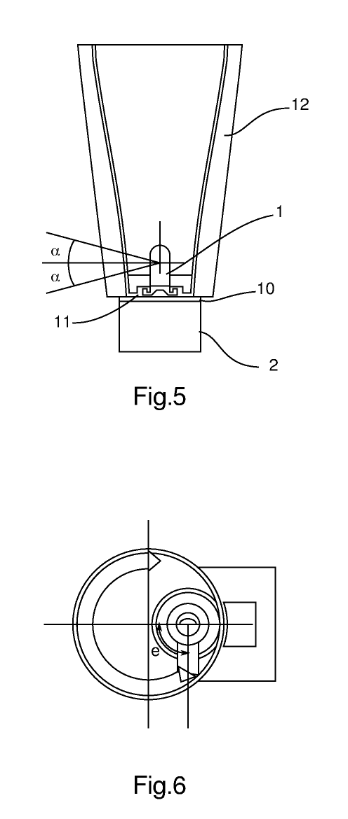

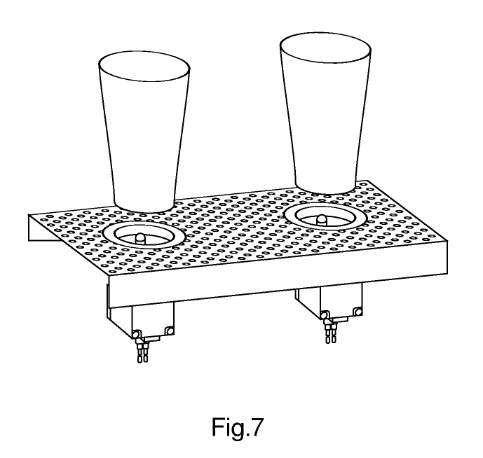

FIGS. 5 and 6 show the angular arrangement in terms of lateral orientation of the injection outlet (9) such that the direction of the jet of beverage follows a path tangential to the lateral wall (12). It will thus be appreciated that the overall arrangement of the nozzle (1) in its container (4) work together to allow the stream lines of the pressurized jet leaving the injection outlet (9) to follow a path with the most laminar flow possible, avoiding any turbulence that would create gaseous emulsions. The geometric shapes of the container (4) and of the nozzle (1) are thus two inseparable characteristic features of the present invention.

For a better understanding of the invention and of the advantages it affords, let us recall the phases of the process used to fill the container (4) via its bottom (11) with the device with filling nozzle (1) and of the associated container (4).

Via a downward manual movement of the container (4), the filling nozzle (1) is introduced through the self-sealing member (5) until it comes into contact with the shoulder (1 0) of the nozzle or any other bearing base provided for that purpose. In this filling position in abutment, the sensor (3) detects the presence of the container (4) in the filling position. It then issues the command to the solenoid valve (2) to open, allowing pressurized beverage to pass into the container (4), the latter remaining sealed as it is being filled in the region of the self-sealing member (5) which hugs the nozzle (1) on its exterior surface.

After a certain programmed filling time, the solenoid valve (2) closes again, halting filling, and the container (4) can then be extracted from the nozzle (1) with an upward movement. The nozzle (1) is then no longer in contact with the self-sealing member (5) and the latter naturally recloses, thus holding the beverage in the container (4). When the user does not wish to extract the container (4) immediately after it has been filled, the nozzle (1) still remains present inside the container (4) for as long as desired, the self-sealing member (5) creating a very good seal against the exterior wall of the nozzle (1). This option thus allows the user to be available to perform other tasks before extracting the container (4) from the nozzle (1) and finishing serving.

It will be noted that, because the head of the nozzle (8) is positioned in the bottom of the container (4), the unidirectional jet leaving the nozzle is always in contact with the beverage already present in the container right from the first few tenths of a second of filling: thus, the beverage does not suffer any warming with the ambient air as is found during conventional filling of a glass or of a carafe from the top. This then avoids an increase in temperature within the liquid during filling, and contributes still further to limiting the formation of foam on beer sensitive to this parameter.

It will also be noted that the injection outlet (9) of the filling nozzle (1), which orients the jet of beverage as low down as possible in the container, avoids any oxidation of the liquid with the ambient air, thus improving its keeping qualities.

By comparison with a filling of a glass performed using the spout of a conventional beer engine, the position of which may be haphazard, the present invention, which ensures that the filling nozzle (1) is always positioned and orientated accurately and identically with respect to the container (4) makes it possible to obtain constant filling repeatability and quality.

A safety-related advantage is also introduced by this arrangement of nozzle (1) which directs the jet of beverage downward. Specifically, in the event of unintentional opening of the solenoid valve (2) which could release a jet of beverage, when the container (4) is not in the filling position, the liquid would easily be collected under gravity by a collecting tray (not depicted).

In another particular embodiment of the invention it is entirely possible to duplicate the number of filling devices so that the operator can fill several containers at the same time.

1. An assembly for filling a beverage container (4), through the bottom (11) thereof, the assembly comprising:
a filling device;
a brverage container exhibiting a circular bottom (11) and a vertical central axis;
the filling device including a solenoid valve (2), a filling nozzle (1) intended to be introduced through a self-sealing member (5) of the container (4),
the filling nozzle (1) including an internal duct and an injection outlet (9), the filling nozzle (1) having a vertical axis off-centered from the center of the bottom (11) of the container (4), and the orientation of the outlet of the injection outlet (9) of which follows an angle (θ) with respect to a plane containing the vertical axis of the container (4), and the vertical axis of the filling nozzle (1), said angle (θ) is greater than 60°, the filling nozzle has a cylinderical exterior shape with a hemispherical or ogee-shaped head (8) for penetrating through the self-sealing member (5) arranged in the bottom (11) of the container (4), and in that the injection outlet (9) of the nozzle (1) is inclined so that it curves progressively downward by a negative angle comprised between −5 and −30°.

2. (canceled)

3. The assembly as claimed in one of claims 1, wherein the filling nozzle (1) includes an internal duct of variable cross section.

4. The assembly as claimed in claim 1, further comprising a part of the supporting structure of the filling device with a shoulder (10) halting an introduction travel of the container (4) and creating a bearing surface.

5. The assembly as claimed in claim 1, further comprising a sensor (3) to detect the presence of the container, and to guide, via its shape, the exterior wall (12) of the container (4) as the nozzle (1) is introduced.

6. The assembly as claimed in claim 1, further comprising a collecting tray intended to catch the beverage when the solenoid valve (2) releases the beverage in the absence of the container (4).

7. The assembly as claimed in claim 1, wherein the self-sealing member (5) is fixed to the bottom (11) of the container (4) by a sealing ring (6) associated with the container (4) by an assembly selected from the group consisting of a mechanical assembly, a chemical assembly, and an assembly by welding to the container (4).

8. The assembly as claimed in claim 1, wherein the self-sealing member (5) is fixed or embedded actually within the very thickness of the material of the bottom (11) of the container (4).

9. (canceled)

10. An apparatus comprising:
at least two assemblies as claimed in claim 1.
